(19) United States
(12) Patent Application Publication
(10) Pub. No.: US 2006/0122974 A1
(43) Pub. Date: Jun. 8, 2006

(54) System and method for a dynamic content driven rendering of social networks

(76) Inventor: Igor Perisic, San Mateo, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/004,249

(22) Filed: Dec. 3, 2004

(51) Int. Cl. G06F 17/30

(52) U.S. Cl. 707/3

(57) ABSTRACT

A search request is received at an information retrieval system. A repository of objects are searched for relevant objects based upon the search request. Parties are identified as parties who interacted with or are mentioned within the relevant objects. A relation score is determined for each pair of parties. A map is created based upon the relation scores of all the pairs of parties. The map is displayed such that the relation scores of the pairs of parties are shown. The determination of the relation score can be weighted by each relevant object's relevancy score. The relation score can also be dependent upon the each party's interactions with or mentions within the relevant objects, and the time lapse between one party's the interaction with or mention within a relevant object, and that of another party.

### BACKGROUND OF THE INVENTION

1. Field of the Invention

The present invention relates generally to social networks, and more particularly to a system and method for rendering social networks based upon the relations of various parties with objects, such as documents.

2. Description of the Related Art

With the proliferation of corporate networks and the Internet, relationships between widely scattered persons have increased dramatically. Consequently, social networks have also increased in size. These networks are useful when one person wishes to contact another person with whom the first person has never met or to whom the first person has never been introduced. In such cases, a mutual acquaintance may serve as a go-between to introduce one to the other. In a social setting, if a first member wishes to meet with a second member, a member who knows both the first and second members can arrange a meeting. In a corporate setting, a high ranking officer in a first organization can be reached by a member of a second organization through an introduction by a person in the first organization who knows the member of the second organization.

Another instance in which social networks are useful is where the withdrawal of a certain member from a social network will leave the network with a disconnected member. For example, if the only connection that a first member has to the network is through a second member, then the withdrawal from the network of the second member will leave the first member disconnected from the network. Applied in a corporate setting, the rendering of such social networks is an important tool for evaluating whether the departure of an employee will leave a customer without a contact within the corporation.

Also, if an employee is identified as being an expert in a particular technology or field and he/she is the only contact with that particular expertise within the organization, then contact between the other employees and the expert should be formed in order to minimize the loss of information that may occur if the expert unexpectedly leaves the organization.

Furthermore, in a social setting where the goal is to have all members within a social network intermingle, the mapping of the social network is helpful in identifying the members who are not familiar with the other members (as determined by the number of connections each member has to other members) and who should be invited to more gatherings to allow for more mingling opportunities.

Generally, existing computerized social networks are created when a first member provides personal information and/or link information that lists a set of acquaintances or collaborators of the first member. Once the first member is linked with the set of acquaintances or collaborators, then all the members who are linked to the set of acquaintances and collaborators become accessible to the first member. Frequently, these social networks are dedicated, or become dedicated through use, to either social or business purposes. These social networks can often be searched by members so that members can create direct links to other members who were not included in their initial link information. Additionally, many of these social networks offer ready-made sub-networks based upon interests or industry affiliation so that members may join a sub-network to expand their personal social networks in a dedicated or specialized manner.

Existing computerized social networks include FRIENDSTER, EVERYONE'S CONNECTED, RYZE, ECADEMY, and LINKEDIN. FRIENDSTER and EVERYONE'S CONNECTED are online networks of friends. When joining these online networks, a first member must provide a list of email addresses of friends. These friends are linked to the first member and form a personal social network of the first member. If these friends also join the network, then the personal social networks of these friends also become accessible to the first member.

RYZE, ECADEMY, and LINKEDIN are business oriented social networks. The members of these business oriented social networks are organized based upon listed interests. When a new member joins, he is required to submit personal information and a listing of his interests. The new member can then link to his friends who are already members of the network, search the network for other members with the same interests, or join special networks comprised of members within a certain industry, who have a particular interest, or reside in a specific location.

A shortcoming of these existing social networks is that their formation requires a member to manually provide private information (e.g., lists of email addresses for members, personal profiles of interests, occupation, and location). In addition, the provided information must be accurate and complete for the social networks to provide the highest level of usefulness. It is difficult, however, to provide information for old acquaintances.

Another shortcoming of these existing social networks is that they only indicate whether a relation exists between each pair of members, and not the strength of the relation. So, the link between business partners who have worked together for decades has the same appearance as that of two employees who only began working together recently.

A further shortcoming of these existing social networks is their accuracy. The existing social networks are based upon information submitted by their members regarding their acquaintance with each other, not upon actual evidence of acquaintance. Consequently, two members can become connected as acquaintances without ever actually having been introduced to one another. This reduces the overall value of the social network, as referrals that include members that are not actually acquainted are less dependable than referrals between members who are actually acquainted.

Therefore, a need exists in the art for a dynamic system and method for representing networks of members such that the representation is not dependant upon personal information supplied by members to the network. The system or method should also indicate the strength of acquaintance or interaction between members, and that improves the accuracy with which interaction between members is represented.

### BRIEF SUMMARY OF THE INVENTION

According to the invention, there is provided a computer implemented method for representing parties based upon their interactions with objects or based upon their being mentioned in the same objects, such that the representation indicates the strength of relation between the parties. A search request containing one or more search terms is received. A plurality of objects are searched based upon the search request. The plurality of objects may also be searched based upon additional search terms found (for example, by using a thesaurus) related to the search request. Objects may include: content objects, such as documents, comments, folders, notes, appointment entries, to-do lists, or journal entries; source objects, such as URLs or file directory paths; people objects, such as experts, peers, workgroups, profiles, or electronic business cards, or the like. At least one located object is found from the plurality of objects. Each located object has at least two parties who either interacted with the object or was mentioned in the object. Then, for each pair of parties, a relation score is determined, and a representation of the parties that indicates the relation score for each pair of parties is created.

The relation score may be determined from predetermined relation pair values for pairs of occurrences in which parties interacted with or were mentioned in objects. These relation pair values may be different for different time ranges between first and second interactions with or mentions within objects. Or, relation pair values which are not associated with time ranges may be used in conjunction with an adjustment derived from the specific amount of time lapse between a first and a second interaction with or mention within an object. The relation score may also be dependent upon a relevancy score for each relevant object.

A map is subsequently created based upon the parties and their paired relation scores. The map consists of nodes that represent the parties and edges that represent relation between pairs of parties. The map may be displayed such that only relation between parties above a predetermined score, below a predetermined score, or within a predetermined range of scores are represented. Also, the relation between parties may be indicated using numbers, color, or edge thickness. Further, an expertise score may be derived for each party, and the appearance of each of the nodes in the map may indicate each of their expertise scores.

The invention thus generates a representation of a social network based upon actual interactions between the members or references to members without requiring the members to submit personal information. The invention also indicates the strength of acquaintance or interaction between the members.

### BRIEF DESCRIPTION OF THE DRAWINGS

Additional features of the invention will be more readily apparent from the following detailed description and appended claims when taken in conjunction with the drawings, in which:

FIG. 1 is a block diagram of a system architecture for a system for mapping parties based upon their interaction with objects;

FIG. 2 is a block diagram of a creator device, contributor device, or searcher device, as shown in FIG. 1;

FIG. 3 is a block diagram of the information retrieval system and repository of FIG. 1;

FIG. 4 is a flow chart of a method for object collection;

FIG. 5A and 5B are a flow chart of a method for representing parties and their relationships;

FIGS. 6 is a diagram of objects, parties, and the interactions of the parties with the objects and the parties being mentioned in the objects;

FIGS. 7-10 and 12 are examples of a social network based upon different embodiments of the invention;

FIG. 11 is an example of a table of predetermined relation pair values; and

FIG. 13 is an example of a table of predetermined time-dependent relation pair values.

### DETAILED DESCRIPTION OF THE INVENTION

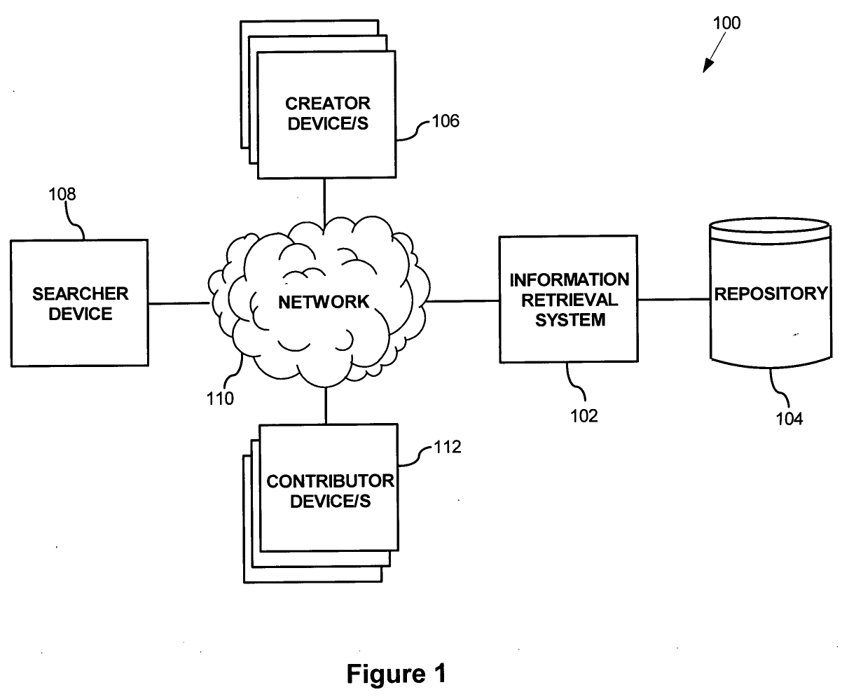

FIG. 1 is a block diagram of a system architecture 100 for a system for representing parties based upon their interaction with, or mention within, objects. The system includes an information retrieval system 102 coupled to a repository 104 and a network 110. Also coupled to the network 110 are a searcher device 108, one or more creator device(s) 106, and one or more contributor device(s) 112. Searcher device 108, creator device(s) 106, contributor device(s) 112, and information retrieval system 102 are all computing devices, such as clients, servers, or the like. The network is preferably a Local Area Network (LAN), but alternatively may be any network, such as the Internet. It should be appreciated that although searcher device 108, creator device(s) 106, contributor device(s) 112, and information retrieval system 102 are shown as distinct entities, they may be combined into one or more devices.

The repository 104 is any storage device(s) that is capable of storing data, such as a hard disk drive, magnetic media drive, or the like. The repository 104 is preferably contained within the information retrieval system 102, but is shown as a separate component for ease of explanation. Alternatively, the repository 104 may be dispersed throughout a network, and may even be located within the searcher device 108, creator device(s) 106, and/or contributor device(s) 112. The Internet, a network of computing devices dispersed across several locations, can also serve as the repository 104.

Each creator device 106 is a computing device operated by a creator who creates one or more objects. Each contributor device 112 is a computing device operated by a contributor who contributes to an object by, for example, adding to, commenting on, viewing, printing, or otherwise accessing objects created by creator(s). The searcher device 108 is a computing device operated by a searcher who is conducting a search for a social network representation based upon the interactions of various parties who have collaborated on a subject matter described by a search request. The searcher, creator(s), and contributor(s) are not limited to the above described roles and may take on any role at different times. Also, the searcher, creator(s), and contributor(s) may browse the repository 104 without the use of the information retrieval system 102.

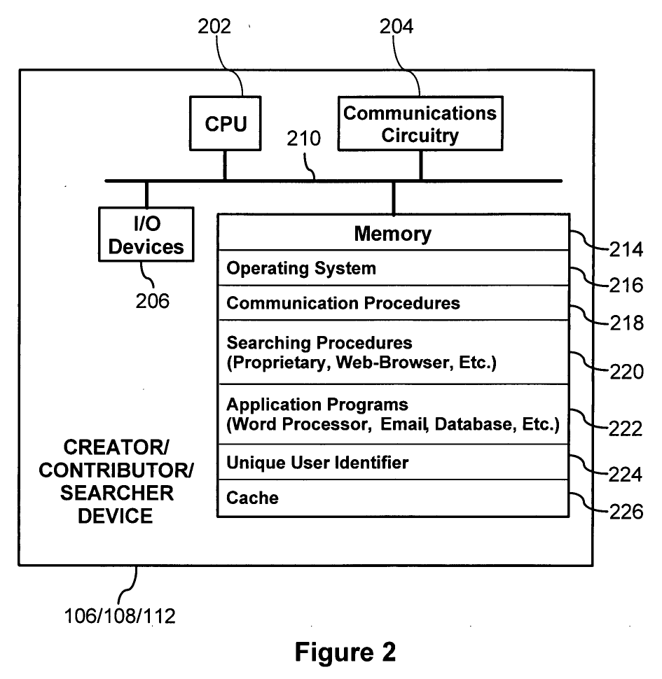

FIG. 2 is a block diagram of a creator device 106, contributor device 112, or searcher device 108, as shown in FIG. 1. The devices 106/108/112 preferably include the following components: at least one data processor or central processing unit (CPU) 202; a memory 214; input and/or output devices 206, such as a monitor and keyboard; communications circuitry 204 for communicating with the network 110 and information retrieval system 102; and at least one bus 210 that interconnects these components.

Memory 214 preferably includes an operating system 216, such as, but not limited to, VXWORKS, LINUX, or WINDOWS, having instructions for processing, accessing, storing, or searching data, etc. Memory 214 also preferably includes communication procedures 218 for communicating with the network 110 and information retrieval system 102; searching procedures 220, such as proprietary search software, a Web-browser, or the like; application programs 222, such as a word processor, email client, database, or the like; a unique user identifier 224; and a cache 226 for temporarily storing data. The unique user identifier 224 may be supplied by the creator/searcher/contributor each time he or she performs a search, such as by supplying a username. Alternatively, the unique user identifier 224 may be the user's login username, Media Access Control (MAC) address, Internet Protocol (IP) address, or the like.

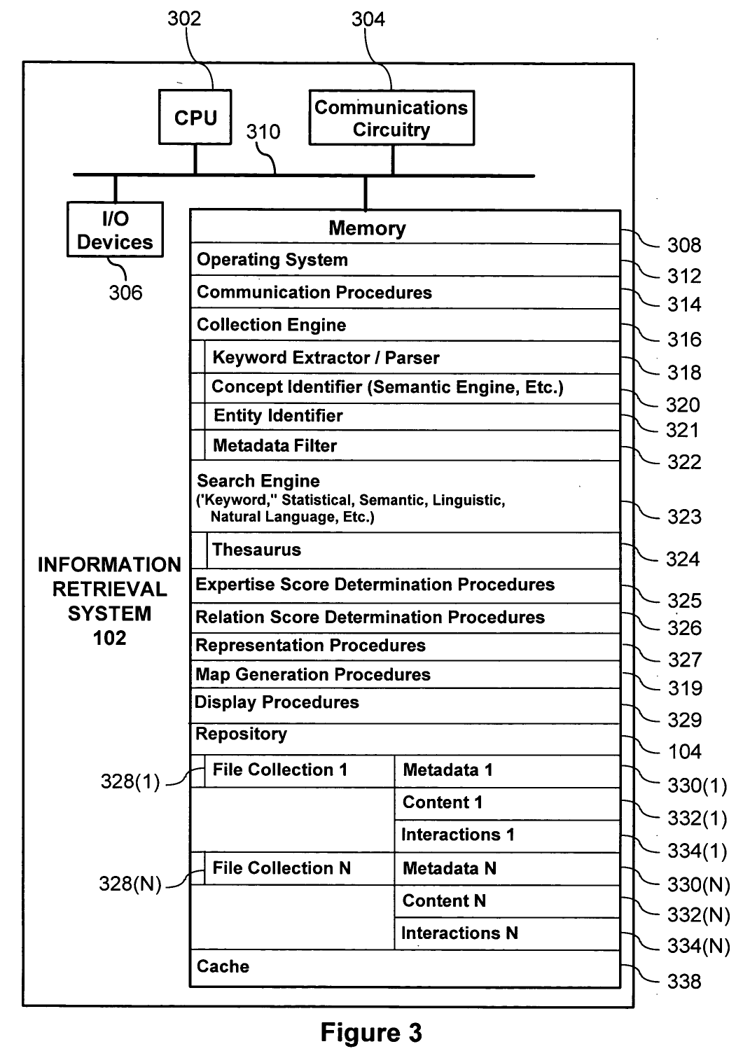

FIG. 3 is a block diagram of the information retrieval system 102 and repository 104 of FIG. 1. As mentioned in relation to FIG. 1, in some embodiments, the repository 104 is contained within the information retrieval system 102. The information retrieval system 102 may include the following components: at least one data processor or central processing unit (CPU) 302; a memory 308; input and/or output devices 306, such as a monitor and keyboard; communications circuitry 304 for communicating with the network 110, creator device(s) 106, contributor device(s) 112, and/or searcher device 108; and at least one bus 310 that interconnects these components.

Memory 308 preferably includes an operating system 312, such as but not limited to, VXWORKS, LINUX, or WINDOWS, having instructions for processing, accessing, storing, or searching data, etc. Memory 308 also preferably includes communication procedures 314 for communicating with the network 110, creator device(s) 106, contributor device(s) 112, and/or searcher device 108; a collection engine 316 for receiving and storing objects; a search engine 323; expertise score determination procedures 325; relation score determination procedures 326; parties representation procedures 327; map generation procedures 319; display procedures 329; a repository 104, as shown in FIG. 1; and a cache 338 for temporarily storing data.

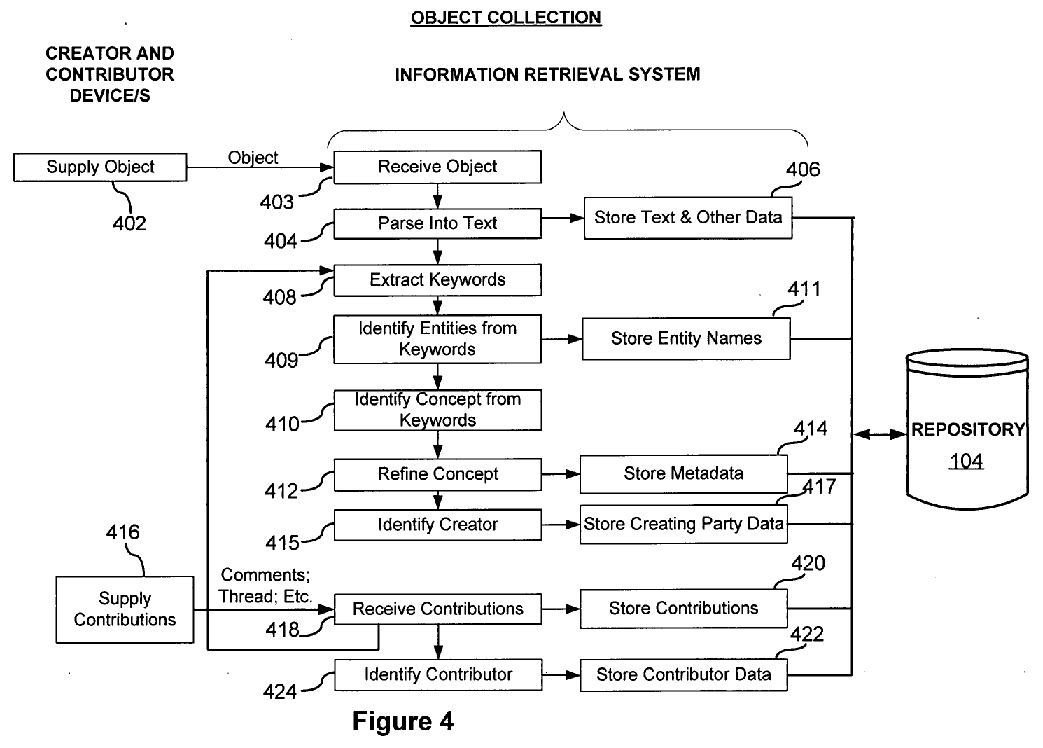

The collection engine 316 may comprise a keyword extractor or parser 318 that extracts text and/or keywords from any suitable object, such as an ASCII or XML file, Portable Document Format (PDF) file, word processing file, or the like. The collection engine 316 also preferably comprises a concept identifier 320. The concept identifier 320 is used to extract the object's important concepts. The concept identifier may be a semantic, synaptic, or linguistic engine, or the like. In a preferred embodiment the concept identifier 320 is a semantic engine, such as TEXTANALYST made by MEGAPUTER INTELLIGENCE Inc. Additionally, the collection engine 316 may preferably comprise an entity identifier 321. The entity identifier 321 is used to extract the names of entities from the object. Furthermore, the collection engine 316 may also comprise a metadata filter 322 for filtering and/or refining the concept(s) identified by the concept identifier 320. Once the metadata filter 322 has filtered and/or refined the concept, metadata about each object is stored in the repository 104. Further details of the processes performed by the collection engine 316 are discussed in relation to FIG. 4. In addition to refined concepts, metadata includes any data, other than raw content, such as text, associated with a object.

The search engine 323 is any standard search engine, such as a keyword search engine, statistical search engine, semantic search engine, linguistic search engine, natural language search engine, or the like. In a preferred embodiment, the search engine 323 is a semantic search engine. The search engine 323 may also include a thesaurus 324 that generates related or similar words to a search term. These similar or related words may then be used to search the repository 104.

The expertise score determination procedures 325 are used to determine the expertise score of a party, and may be based upon the party's interaction with objects, or the party's intrinsic properties. Expertise score determination procedures 325 based upon a party's interaction with objects are described in Perisic, et al., US Patent Application Pub. No. US 2003/0233345 A1, “System and Method for Personalized Information Retrieval Based On User Expertise”, which is hereby incorporated by reference. The relation score determination procedures 326 are used to determine the relation score for a pair of parties. The representation procedures 327 are used to calculate a representation of the parties based upon their relation scores. The map generation procedures 319 are used to generate a map based upon the representation of the parties created by the representation procedures 327. The display procedures 329 are used to display the generated map.

A file collection 328(1)-(N) is created in the repository 104 for each object input into the system. Each file collection 328(1)-(N) preferably contains: metadata 330(1)-(N), such as associations between keywords, concepts, or the like; content 332(1)-(N); and interactions 334(1)-(N), such as read, print, edit, or the like. At a minimum, each file collection may contain content 332(1)-(N) and interactions 334(1)-(N) for each object.

FIG. 4 is a flow chart of a method for object collection. Interactions include creating and contributing to objects. A creator supplies an object to the searching procedures 220 at step 402. To supply an object, the creator may, for example, supply any type of data file that contains text, such as an email, word processing document, text document, graphic having associated text, structured or unstructured data file that contains text, associated text, database transaction record, or the like. An object comes from a source of the object. Therefore, to supply a source, the creator may simply provide a link to an object, such as by providing a URL to a Web-page on the Internet, supply a directory that contains multiple objects, or provide the IP addres to proprietary systems that are not accessible through a URL, such as a DOCUMENTUM SYSTEM, LIVELINK, or LOTUS NOTES SYSTEM.

The object is then sent to the information retrieval system 102 (FIG. 1) by the communication procedures 218 (FIG. 2). The information retrieval system 102 (FIG. 1) receives the object at step 403. When supplied with an object, the keyword extractor or parser 318 (FIG. 3) attempts to parse the object at step 404. If the object includes text, the extractor or parser then extracts the important keywords at step 408. Extraction of keywords also includes the extraction of parties' names mentioned in the object. Each party name extracted from the object is then identified in step 409 and stored in the repository 104 at step 411. When the object supplied is a source, such as a URL, the keyword extractor or parser 318 (FIG. 3) first obtains the document(s) from the source before parsing the important keywords into text.

Extraction of important keywords is undertaken using any suitable technique. Any extracted text and/or other data are then stored at step 406 in the repository 104 as part of a file collection 328(1)-(N) (FIG. 3). The concept identifier 320 (FIG. 3) may then identify the important concept(s) from the extracted keywords at step 410. The metadata filter 322 (FIG. 3) may then refine the concept at step 412, and store it in the repository 104 as part of the metadata 330(1)-(N) (FIG. 3) within a file collection 328(1)-(N) (FIG. 3). At step 415, the creator is identified and the creator data is stored at step 417 in the repository 104 as interactions 334(1)-(N) (FIG. 3). For example, the data stored can include the creator's identity and time and date of creation.

At any time, contributors can supply their contributions, at step 416, such as by supplying additional comments, threads, or other activity to be associated with the file collection 328(1)-(N) (FIG. 3). These contributions are received by the information retrieval system at step 418 and stored in the repository at step 420, as further interactions 334(1)-(N) (FIG. 3). At step 422, the party that contributed to the object is identified and the contributor data (including the party's identity, contribution, and time and date of contribution) is stored, at step 422, in the repository 104. The contributions are then analyzed to extract keywords at step 408, to identify entities from the keywords at step 409, to identify the concepts at step 410, to refine the concepts at step 412 and stored as metadata to repository 104 at step 414. Alternatively, contributions may be received and treated in the same manner as a document or source, i.e., steps 403-414.

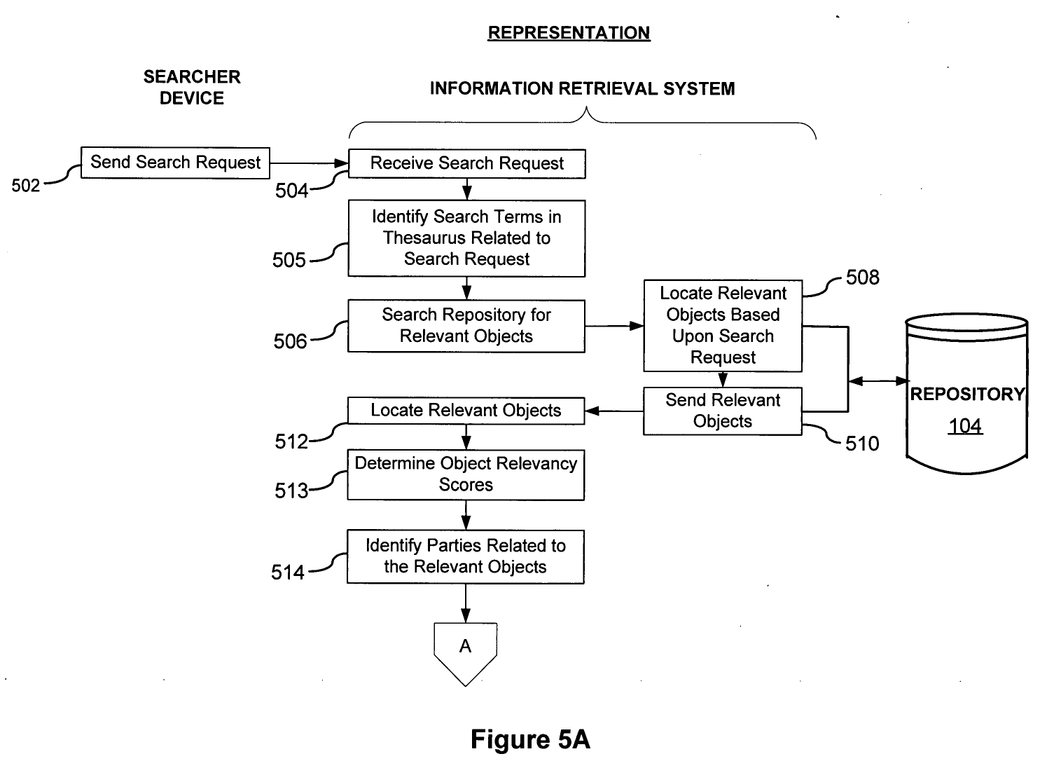

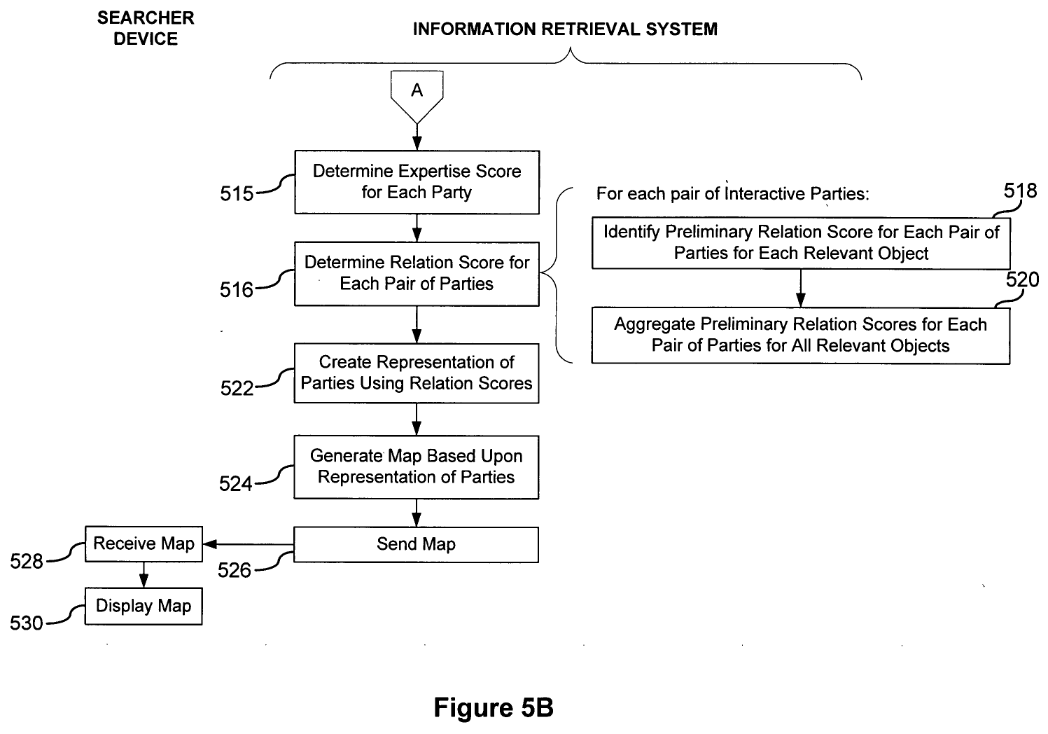

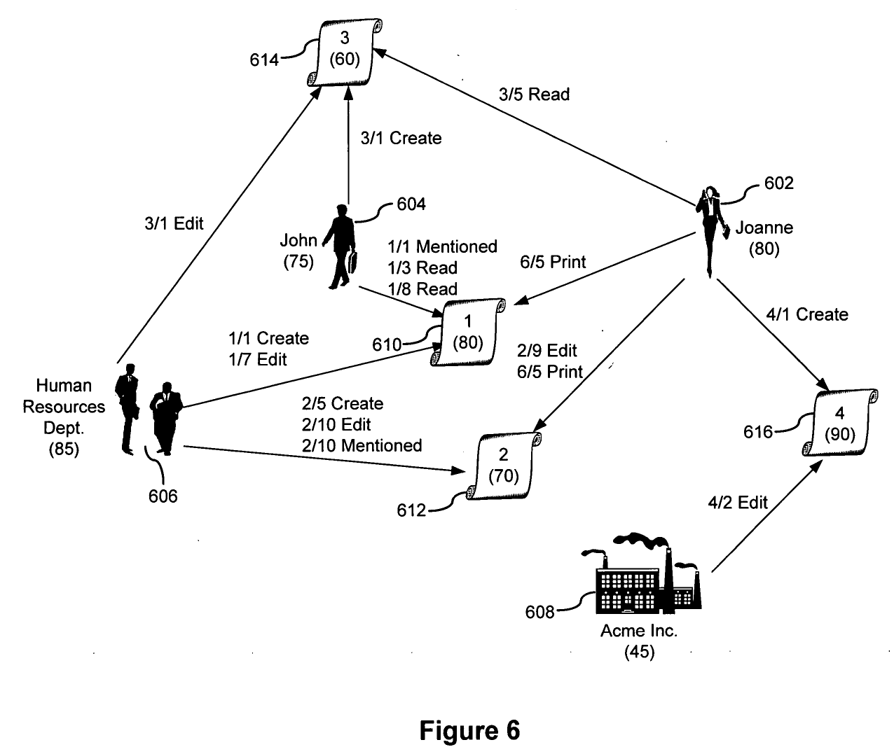

FIGS. 5A and 5B combined are a flow chart for creating a representation of parties based upon their relation, and describes a preferred embodiment of the invention. FIG. 6 is an exemplary diagram of objects 610, 612, 614, and 616, parties 602, 604, 606, and 608, and the date and type of the parties' interactions with or mentions within the objects (text along the arrows linking parties 602, 604, 606, and 608, to objects 610, 612, 614, and 616). The numbers in parentheses under the parties' names indicate each party's expertise score. The numbers in parentheses on the objects indicate each object's relevancy score. As FIG. 6 indicates, parties may be individuals (602, 604), departments within organizations (606), or entire organizations (608). Parties, however, are not limited to these and may also be non-human entities, including products and services. FIG. 6 will serve as a working example to better describe the flow chart of FIGS. 5A and 5B.

Returning to the flowchart in FIG. 5A, a searcher using a searcher device 108 (FIG. 1) submits a search request to the information retrieval system 102 (FIG. 1) at step 502. Submittal of this search request occurs using searching procedures 220 (FIG. 2) and communication procedures 218 (FIG. 2) on the searcher device 108 (FIG. 1). The search request may contain one or more search terms, such as “plastic AND widget”. For example, in FIG. 6, John (party 604), wishing to create a representation of parties who collaborated on the research and design of plastic widgets, may submit, through on searcher device 108 (FIG. 1), a search request “plastic AND widget” to the information retrieval system 102 (FIG. 1).

The search request is received at step 504 by the information retrieval system 102 (FIG. 1) using communications procedures 314 (FIG. 3). In one embodiment, the information retrieval system 102 (FIG. 1) may, at step 505, identify additional search terms (using a thesaurus or the like) related to the original search request. The information retrieval system 102 then searches the repository 104 for relevant objects, at step 506, using the search term received at step 504 and the additional search terms determined at step 505, if step 505 was performed. This search is undertaken by the search engine 324 (FIG. 3) at step 506, using any known or yet to be discovered search techniques. In a preferred embodiment, the search undertakes a semantic analysis of each file collection 328(1)-(N) (FIG. 3) stored in the repository 104 (FIG. 1). The search engine 324 subsequently locates relevant objects stored in file collections 328(1)-(N) (FIG. 3) at step 508 and returns the relevant objects at step 510. The relevant objects are received, and, thereby located at step 512. For example, in FIG. 6, the relevant objects located at step 512 are represented by objects 610, 612, 614, and 616, with relevancy scores 80, 70, 60, and 90, respectively.

At step 514, the parties that interacted with or are mentioned within the relevant objects are identified. The relation score determination procedures 326 (FIG. 3) then determine a relation score for each pair of parties at step 516. In one embodiment of the invention, the determination of the relation score for each pair of parties at step 516 includes identifying a preliminary relation score for each pair of parties for each relevant object at step 518, and then aggregating the preliminary relation scores for each pair of parties for all relevant objects at step 520. In another embodiment of the invention, and expertise score for each party is determined at step 515.

One method for determining (step 518) and then aggregating (step 520) preliminary relation scores for a pair of parties is embodied in the following formula:

$${s}_{ij} = {{\sum }_{{Obj}_{k} ∈ \{ Relevant Objs \}}^{}}_{{ω}_{{sem}_{{Obj}_{k}} \geq {T}_{{ω}_{sem}}}} {ω}_{{sem}_{{Obj}_{k}}} f ( {A}_{ij} ∈ \{ Relation with {obj}_{k} \} ) \qquad ( 1 )$$

where sᵢⱼ is the relation score for parties i and j; ƒ(Aᵢⱼε{Relation with objₖ}) is a function evaluated on the set of relations between parties i and j on object k; and ωₛₑₘ_{_{Objk}} is the relevancy score for object k (in this illustration, it is the relevancy score attributed to the semantic score). Note that determination of the relation score can be restricted to use only objects that have a relevancy score above a predetermined value. In formula (1), the value is 60(T_{ω}_{ₛₑₘ}=60). The purpose of this value is to filter out any objects that are not sufficiently relevant. Note that this threshold could be 0 and not filter any objects.

In one embodiment, the determination of the relation score involves considering only whether both parties in the pair of parties either interacted with or were mentioned within the same relevant object with no regard to the relevancy score of the relevant objects (except to eventually limit the use of relevant objects to those with relevancy scores above a threshold value, such as 60):

$${s}_{ij} = {{\sum }_{{Obj}_{k} ∈ \{ Relevant Objs \}}^{}}_{{ω}_{{sem}_{{Obj}_{k}} \geq {T}_{{ω}_{sem}}}} {1}_{\vert \{ {A}_{ij} ∈ \{ Relation with {obj}_{k} \} \} \geq 1 \vert} \qquad ( 2 )$$

If both parties in the pair of parties interacted with or were mentioned within a relevant object, then the preliminary relation score would be 1, independent of the type of actions performed on that object. If only one or neither of the parties either interacted with or were mentioned within a relevant object, then the preliminary relation score would be 0. Applying this formula to the example in FIG. 6, step 522 of FIG. 5 is performed and the following representation is created based upon the resultant relation scores for the parties:

TABLE 1

| | John | Joanne | HR | Acme |
|---|---|---|---|---|
| John | X | 2 | 2 | 0 |
| Joanne | 2 | X | 3 | 1 |
| HR | 2 | 3 | X | 0 |
| Acme | 0 | 1 | 0 | X |

Note that the scores are symmetrical. In other words, the X-Y score should be the same as the Y-X score because this embodiment only tallies the number of relevant objects in common between each pair of parties.

In some embodiments, before the determination of the relation score at step 516, the expertise score determination procedures 325 (FIG. 3) determine the expertise score for each party based upon the party's interaction with or mention within the relevant objects at step 515. The expertise of a party, however, is but one example of a property intrinsic to the party that can be used to determine the party's expertise score. Other properties intrinsic to a party include properties based upon the party's relative position in the network (“network values”), such as the centrality of the party (as determined by the number of parties related to the party), the closeness of the party (as determined by the average number of parties between the party and all other parties in the network), and the betweeness of the party (as determined by number of critical paths on which the node representing the party sits. Properties intrinsic to a party also include properties based upon the party's individual characteristics (“individual values”), such as expertise, age, years to retirement, department, salary, capitalization value, and market share. In a further embodiment, this expertise score is used in identifying the relation score at step 516 by, for example, averaging two parties' expertise scores and assigning this average as the pair's relation score.

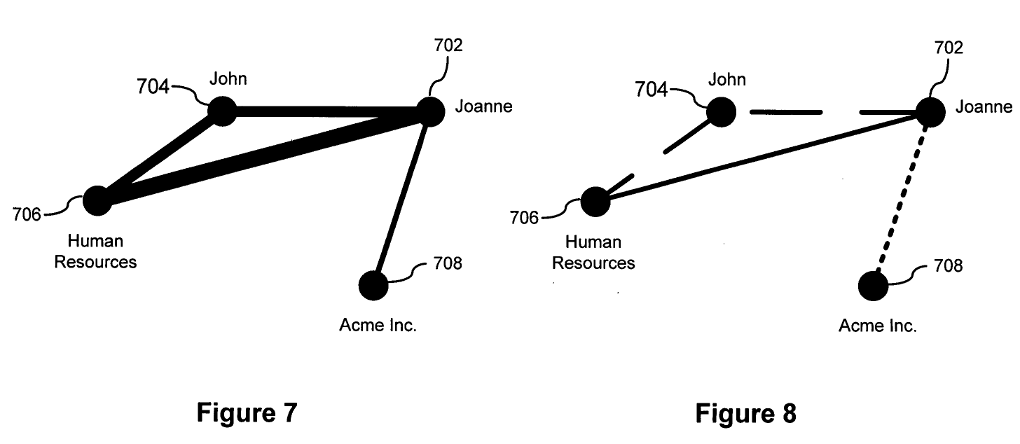

In some embodiments, relation scores determined in step 516 are used, at step 524, to generate a map consisting of nodes that represent parties and edges connecting pairs of nodes that represent pairs of parties with relation scores above zero. Examples of these maps are described below in relation to FIGS. 7-10. The information retrieval system 102 (FIG. 1) then sends the map to the searcher device 108 (FIG. 1), at step 526. At step 528, the searcher device 108 (FIG. 1) receives the map, and displays the map at step 530, to the searcher.

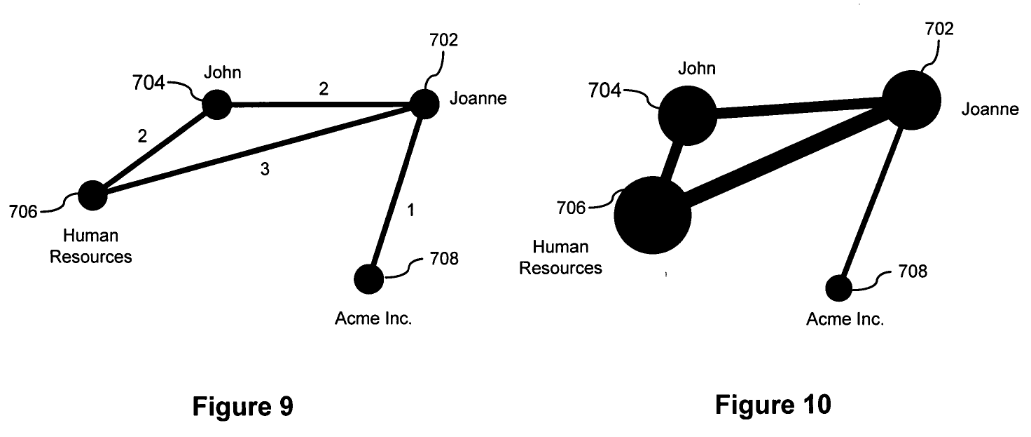

FIG. 7 shows a particular embodiment wherein the edges of the map have varying thickness to indicate the relative strength of the relations as indicated by the relation scores. FIG. 8 shows another embodiment wherein the color or line type of the edges vary to indicate the relative strength of relations. FIG. 9 is a further embodiment wherein numbers are used to indicate the relation strengths between the parties. Finally, FIG. 10 shows yet another embodiment in which the expertise scores of the parties are indicated using varying sizes of nodes. Other embodiments include using various combinations of colors and numbers to indicate the expertise score of the parties.

In yet another embodiment, the method in Formula 2 can be tailored by using the relevancy score of each relevant object to weigh the preliminary relation scores:

$${s}_{ij} = {{\sum }_{{Obj}_{k} ∈ \{ Relevant Objs \}}^{}}_{{ω}_{{sem}_{{Obj}_{k}} \geq {T}_{{ω}_{sem}}}} {ω}_{{sem}_{{Obj}_{k}}} {1}_{\vert \{ {A}_{ij} ∈ \{ Relation with {obj}_{k} \} \} \geq 1 \vert} \qquad ( 3 )$$

Applying this formula to the example in FIG. 6 with a threshold value of 70, step 522 of FIG. 5 is performed and the following representation is created based upon the resultant relation scores for the parties:

TABLE 2

| | John | Joanne | HR | Acme |
|---|---|---|---|---|
| John | X | 80 | 80 | 0 |
| Joanne | 80 | X | 150 | 90 |
| HR | 80 | 150 | X | 0 |
| Acme | 0 | 90 | 0 | X |

For example, the relation score between John and Joanne of 80 is obtained by adding the product of 80 (the relevancy score of object 610) and 1, the product of 70 (the relevancy score of object 612) and 0, the product of 60 (the relevancy score of object 614) and 0, and the product of 90 (the relevancy score of object 616) and 0.

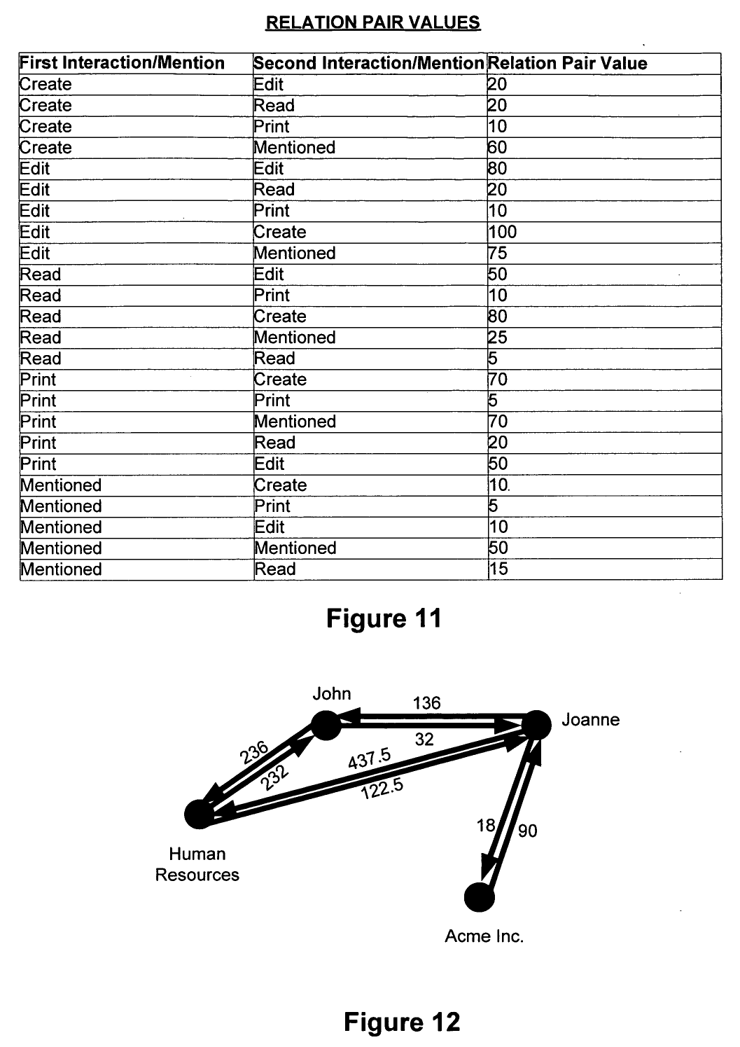

In a further embodiment, the relation score is derived from relation pair values for pairs of interactions or mentions. These relation pair values are predetermined values assigned to different pairs of interactions or mentions as an evaluation of the strength of relation the pair of interactions or mentions indicates. The table in FIG. 11 is an example of a table of relation pair values. In a particular embodiment, the scores can be asymmetrical. In other words, the X-Y score is different from the Y-X score. This is useful in distinguishing the difference in relatedness between two parties. For example, if a party creates an object and another party subsequently edits the object, the editing party has interacted with the creating party, whereas the creating party has not interacted with the editing party. As can be seen in FIG. 11, if one party creates an object and another party edits the same object, the relation pair value for determining the relation score between the creating party and the editing party is 20, and the relation pair value for determining the relation score between the editing party and the creating party is 100.

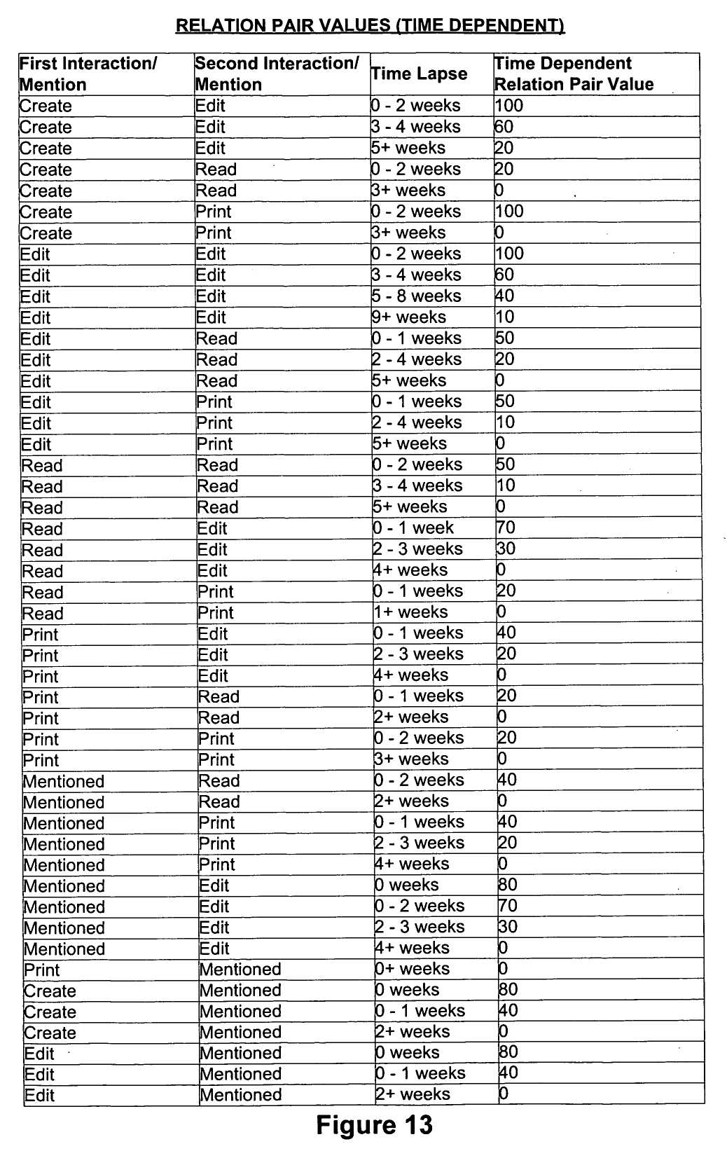

In another embodiment, the relation pair values are dependent on time. As FIG. 13 shows, if a first party creates an object, and a second party edits the object within two weeks, the relation pair value for that pair of interactions is 100. However, if the second party edits the object three weeks after the first party wrote the object, then the relation pair value for that pair of interactions drops to 60. Similarly, if a first party creates an object, and a second party is mentioned within that object at creation, the relation pair value of that pair of interaction and mention is 80. However, if the object is edited two or more weeks after creation such that it mentions the second party, the relation pair value of that pair of interaction and mention drops to 0. In some embodiments, these relation pair values can be predetermined by the searcher who provided the search term. In a further embodiment, the time dependency may be made more specific by taking into account the exact time difference between the first and second interactions and/or mentions instead of using ranges of time. While the time dependency may be combined with an asymmetric system of scoring, this need not be the case.

One formula for incorporating relation pair values into the determination of relation scores is:

$${s}_{ij} = \frac{1}{λ} {{\sum }_{{Obj}_{k} ∈ \{ Relevant Objs \}}^{}}_{{ω}_{{sem}_{{Obj}_{k}} \geq {T}_{{ω}_{sem}}}} {ω}_{{sem}_{{Obj}_{k}}} ( {\sum }_{{A}_{ij} ∈ \{ Relation with {obj}_{k} \}} {w}_{{A}_{ij}} ) \qquad ( 4 )$$

where w_{A}_{ᵢⱼ} is the relation pair value of the pair of interactions or mentions, Aᵢⱼ as is predetermined (for example, in FIG. 11), and λ=100 is a scaling factor as the relation pair values are scaled to a value between 0 and 100. Applying this formula to the example in FIG. 6 and using the asymmetric values in the table in FIG. 11, the following representation is created based upon the resultant relation scores for the parties:

TABLE 3

| | John | Joanne | HR | Acme |
|---|---|---|---|---|
| John | X | 136 | 236 | 0 |
| Joanne | 32 | X | 437.5 | 18 |
| HR | 232 | 122.5 | X | 0 |
| Acme | 0 | 90 | 0 | X |

For example, the relation score between John and Joanne of 136 is obtained by adding the product of 80 (the relevancy score of object 610) and the sum of 70, 20, and 20 (the relation pair values from FIG. 11 for the interaction/mention pairs of print/mention, print/read, and print/read, respectively), and the product of 60 (the relevancy score of object 614) and 80 (the relation pair value from FIG. 11 for the interaction/mention pair of read/create). FIG. 12 shows a map that represents this asymmetric social network.

A particular method only considers the maximum relation pair value of each relevant object:

$${s}_{ij} = \frac{1}{λ} {{\sum }_{{Obj}_{k} ∈ \{ Relevant Objs \}}^{}}_{{ω}_{{sem}_{{Obj}_{k}} \geq {T}_{{ω}_{sem}}}} {ω}_{{sem}_{{Obj}_{k}}} {max}_{{A}_{ij} ∈ \{ Relation with {obj}_{k} \}} ( {w}_{{A}_{ij}} ) \qquad ( 5 )$$

Applying this formula to the example in FIG. 6 and using the asymmetric values in the table in FIG. 11, the following representation is created based upon the resultant relation scores for the parties:

TABLE 4

| | John | Joanne | HR | Acme |
|---|---|---|---|---|
| John | X | 104 | 76 | 0 |
| Joanne | 20 | X | 156 | 18 |
| HR | 120 | 76 | X | 0 |
| Acme | 0 | 90 | 0 | X |

For example, the relation score between John and Joanne of 104 is obtained by adding the product of 80 (the relevancy score of object 610) and the 70 (the maximum relation pair value from FIG. 11 for the interaction/mention pairs of print/mention, print/read, and print/read, respectively), and the product of 60 (the relevancy score of object 614) and 80 (the only, and thusly the maximum, relation pair value from FIG. 11 for the interaction/mention pair of read/create).

The range for the summation of the preliminary relation scores can be adjusted as the summation may dominate and grow infinitely. A way to restrain this growth is through the use of the expit function:

$${s}_{ij} = μ {{\sum }_{{Obj}_{k} ∈ \{ Relevant Objs \}}^{}}_{{ω}_{{sem}_{{Obj}_{k}} \geq {T}_{{ω}_{sem}}}} {ω}_{{sem}_{{Obj}_{k}}} \frac{exp ( Δ x )}{1 + exp ( Δ x )} \qquad ( 6 )$$

where

$$Δ x = ( \frac{1}{λ} {\sum }_{{A}_{ij} ∈ \{ Relation with {obj}_{k} \}} {w}_{{A}_{ij}} ) - β ,$$

λ=100 (the same scaling factor as above), β=5 (slope trigger offsetting factor, the value which the sum must reach for the ratio to be 50%), and μ=2.5 (an activity amplitude adjusting factor).

To take into account the time elapsed between the pairs of interactions and/or mentions of the parties, formulas (4)-(6) above can be used in conjunction with relation pair values that are time dependent (see FIG. 13). For example, when formula (4) is applied using time dependent relation pair values, the following representation is created based upon the resultant relation scores for the parties:

TABLE 5

| | John | Joanne | HR | Acme |
|---|---|---|---|---|
| John | X | 12 | 284 | 0 |
| Joanne | X | X | 198 | 90 |
| HR | X | X | X | 0 |
| Acme | X | X | X | X |

Note that the relation scores for John (party 604) and Joanne (party 602) were 136 and 32 (using a table with asymmetric values) when time was not a factor (see Table 3), but the relation score using a table with symmetric values has become 12 when time is taken into account. This is because, as described in FIG. 6, John (party 604) read object 410 on January 8, but Joanne (party 602) did not print object 410 until June 5, more than one week later. The relation pair value for a first interaction of read and a second interaction of print more than one week later is 0 (see FIG. 12). The time factor also accounts for the difference in the relation score for Joanne (party 602) and HR (party 606).

A more tailored way of accounting for time does not use relation pair values (which are based upon ranges of time). Instead, the actual amount of time elapsed is a factor in the formula. Illustrating this behavior with formula (4) above, the formula becomes:

$${s}_{ij} = \frac{1}{λ} {{\sum }_{{Obj}_{k} ∈ \{ Relevant Objs \}}^{}}_{{ω}_{{sem}_{{Obj}_{k}} \geq {T}_{{ω}_{sem}}}} {ω}_{{sem}_{{Obj}_{k}}} ( {\sum }_{{A}_{ij} ∈ \{ Relation with {obj}_{k} \}} {w}_{{A}_{ij}} * exp ( \frac{Δ ( {time}_{ij} )}{δ} ) ) \qquad ( 7 )$$

where δ is the rate of decay and measures how fast the adjustment goes to 0, and Δ(timeᵢⱼ) is the difference in days between the time of the query and the action time. Varying this formula to use a time defined window (i.e., a square filter within the time adjustments), formula (7) becomes:

$${s}_{ij} = \frac{1}{λ} {{\sum }_{{Obj}_{k} ∈ \{ Relevant Objs \}}^{}}_{{ω}_{{sem}_{{Obj}_{k}} \geq {T}_{{ω}_{sem}}}} {ω}_{{sem}_{{Obj}_{k}}} ( {{\sum }_{{A}_{ij} ∈ \{ Relation with {obj}_{k} \}}}_{{A}_{ij} ∈ \{ Time window \}} {w}_{{A}_{ij}} ) \qquad ( 8 )$$

where Aᵢⱼε{Time window} means that only actions within the time considered (the time window) are to be considered.

Within the previous steps, strength of the relation pair values was linear in the number of objects. While we curbed the effect of each object by performing a timed decay on interactions with or mentions within that object, in some embodiment it may be preferable to use a utility type of behavior on the score across objects. For example:

$${s}_{ij} = {f}_{Util} ( {w}_{{A}_{ij}} ) = ( \frac{1}{λ} log [ β * {{\sum }_{{Obj}_{k} ∈ \{ Relevant Objs \}}^{}}_{{ω}_{{sem}_{{Obj}_{k}} \geq {T}_{{ω}_{sem}}}} {ω}_{{sem}_{{Obj}_{k}}} ( {\sum }_{{A}_{ij} ∈ \{ Relation with {obj}_{k} \}} {w}_{{A}_{ij}} * exp ( \frac{Δ ( {time}_{ij} )}{δ} ) ) ] ) \qquad ( 9 )$$

where the logarithmic function is providing the utility type of behavior, β is an amplitude modifying constant within objects, and δ is the rate of decay and measures how fast the time decay goes to 0. Although the logarithmic function is used in this formula, it can be replaced by any monotone increasing function (convex, concave or part concave and part convex) with a lower or higher rate of increase than the linear function. For example, a more complex variation would be to use the expit function instead of the logarithmic function this would limit the range of the score:

$${s}_{ij} = {f}_{Util} ( {w}_{{A}_{ij}} ) = ( \frac{1}{λ} expit [ {β}^{*} {{\sum }_{{Obj}_{k} ∈ \{ Relevant Objs \}}}_{{ω}_{{sem}_{{Obj}_{k}} \geq {T}_{{ω}_{sem}}}} {ω}_{{sem}_{{Obj}_{k}}} ( {\sum }_{{A}_{ij} ∈ \{ Relation with {obj}_{k} \}} {w}_{{A}_{ij}} * exp ( \frac{Δ ( {time}_{ij} )}{δ} ) ) ] ) \qquad ( 10 )$$

Finally relevant object located by the information retrieval system 102 within the repository 104 may belong to different type of Data Sources. For example, some objects may come from an Email system, some others from a Content Management system (such as, but not limited to, Documentum or Livelink), some “trusted web sites” and others. In such a situation, some Data sources may be more valuable than others. This could also depend on the profile of the searcher. For example, if the searcher is an Engineer, then the pair interactions or mentions scores extracted from objects belonging to a bug tracking tool such as Mercury Test Director would be more relevant (of higher value) than those extracted from collaborative Document Publishing tool mainly used by Marketing. In this case the interaction/mention pairs scores is defined by:

$${s}_{ij}^{final} = {\sum }_{l ∈ \{ Data Sources \}} {α}_{l}^{Sprof} ( {s}_{ij}^{l} ) \qquad ( 11 )$$

where s^{l}ᵢⱼ is any of the relation pair values defined in 4-10 but calculated only on objects within data source 1, αₗ^{Sprof} are weights defining the relative value of each data source towards the final score.

Finally as with the previous developments the more general function determining the relation pair values across datasources would be:

$${s}_{ij}^{final} = g ( {\sum }_{l ∈ \{ Data Sources \}} {α}_{l}^{Sprof} {f}_{l}^{Sprof} ( {s}_{ij}^{l} ) ) \qquad ( 12 )$$

Where g is in a prefered embodiement a utility type of function such as the expit function and the functions ƒₗ^{Sprof} are either the identity functions or a utility type of function limiting the growth of the sum within each data source where they depend on the profile of the searcher. The function g acts as a non-linear scaling function on the overall score whereas the functions ƒₗ^{Sprof} act as cross data source normalizing functions in order to be bring each data source scores on a comparable scale.

As discussed earlier, the existing social networks require members to manually provide personal information or link information. Since the information used to create the network is based upon users' input, the information must be accurate, which may be problematic when the information for acquaintances or business associates is difficult to recall, or even purposely inaccurate. The present invention utilizes information stored in existing objects to recreate the relations between parties. Further, whereas the existing social networks only indicate the existence of a relation between parties, the present invention also indicates the strength of the relation as well as personal information about the parties themselves.

While the foregoing description and drawings represent preferred embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, and with other elements, materials, and components, without departing from the spirit or essential characteristics thereof. The presently disclosed embodiments are therefore to be considered in all respects as illustrative and not restrictive, the scope of the invention being indicated by the appended claims, and not limited to the foregoing description. Furthermore, it should be noted that the order in which the process is performed may vary without substantially altering the outcome of the process.

What is claimed:

1. A computer implemented method for mapping relations between parties, comprising:
receiving a search request concerning one or more search terms;
searching a repository of multiple objects for relevant objects based upon the search request;
locating at least one relevant object in the repository;
identifying two or more parties that are related to the at least one relevant object;
determining a relation score for each pair of the two or more parties; and
generating a representation of a relationship between the two or more parties, based on the relation score for each pair of the two or more parties.

2. The method in claim 1, wherein the multiple objects include content objects, people objects, and source objects.

3. The method of claim 1, further comprising:
prior to the locating, using a thesaurus to determine at least one additional search term; and
searching the repository of multiple objects for relevant objects based upon the such terms and the at least one additional search term.

4. The method of claim 1, wherein the searching is undertaken using a search technique selected from a group consisting of: semantic processing, syntactic processing, natural language processing, statistical processing, and any combination of the aforementioned techniques.

5. The method of claim 1, wherein the two or more parties are related to the at least one relevant object if each of the two or more parties interacted with the relevant object or were mentioned within the relevant object.

6. The method of claim 1, wherein the parties include individuals, brands, places, and any of their aggregates.

7. The method of claim 6, wherein the individual aggregates include individuals within a business unit, individuals within a corporation, or individuals within an industry.

8. The method of claim 7, wherein the individual aggregates further include individuals within a geographical boundary, individuals with a certain expertise, individuals with a certain capability, or individuals with a certain personal attribute.

9. The method of claim 1, wherein the determining further comprises for each pair of two or more parties:
calculating a preliminary relation score of the pair of parties for the at least one relevant object, where the preliminary relation score is dependent upon relations of each party of the pair of parties with the at least one relevant object; and
aggregating preliminary relation scores of the pair of parties for all the relevant objects.

10. The method of claim 9, further comprising:
prior to the calculating, determining a relevancy score for each relevant object; and
wherein the calculating further comprises:
determining a raw score for the at least one relevant object based upon the relations of the pair of parties with the at least one relevant object; and
weighting the raw score with the relevancy score to obtain the preliminary scores for each identified parties;

11. The method of claim 9, wherein the aggregating further comprises:
summing all preliminary relation scores for the pair of parties; and
adjusting the sum of all preliminary relation scores.

12. The method of claim 10, wherein only relevant objects having a relevance score above a predetermined relevancy score are used in determining the relation scores.

13. The method of claim 10, wherein the raw score is 1 if both parties interacted with the relevant object, and the raw score is 0 if less than both of the parties are related to the relevant object.

14. The method of claim 12, wherein the relevancy score is set to 1 for all relevant objects.

15. The method of claim 9, further comprising:
prior to the calculating, determining an expertise score for each party; and
wherein the calculating is a function of the expertise scores for each pair of parties.

16. The method of claim 10, wherein the raw score is derived from relation pair values for pairs of interactions and/or mentions, the relation pair values indicating the degree of relation between pairs of parties based upon each party's interactions with or mentions within a common relevant object.

17. The method of claim 15, wherein the search request is provided by a searcher and the type of relation pair values to consider in calculating are predetermined by the searcher.

18. The method of claim 16, wherein the relation pair values are time dependent.

19. The method of claim 10, wherein the raw score is further based upon the time elapsed between each of the pair of parties' interactions with or mentions within the relevant object.

20. The method of claim 16, wherein the relation pair value is based upon the source of the at least one relevant object.

21. The method of claim 20, wherein the relation pair value is further based upon a searcher profile.

22. The method of claim 1, further comprising:
generating a map based upon the relationship between the parties, the map consisting of nodes that represent the parties and edges connecting pairs of nodes that represent pairs of parties with relation scores above zero; and
displaying the map.

23. The method of claim 22, wherein only edges representing aggregate relation scores above a predetermined score, below a predetermined score, or within a predetermined range of scores are displayed.

24. The method of claim 22, wherein the displaying step is undertaken using color to indicate the aggregate relation score.

25. The method of claim 22, wherein the displaying step is undertaken using a number associated with the edges to indicate the aggregate collaboration score.

26. The method of claim 22, wherein the displaying step is undertaken using varying sizes of edges to indicate the aggregate collaboration score.

27. The method of claim 15, further comprising:
generating a map based upon the representation of the parties, the map consisting of nodes that represent the parties and edges connecting pairs of nodes that represent pairs of parties with relation scores above zero, above a predetermined score, below a predetermined score, or within a predetermined range of scores; and
displaying the map, wherein the expertise score of each party is indicated by the color, size, or shape of the nodes, or by a number adjacent to the node.

28. The method of claim 15, wherein the expertise score of each party is a score based on a certain property of the party.

29. The method of claim 28, wherein the property is the expertise of the party.

30. The method of claim 28, wherein the property is based on the party's intrinsic properties.

31. The method of claim 30, wherein the intrinsic properties are personal to the party, such as age, years to retirement, job title, department, location of employment, salary, affiliations, and memberships.

32. The method of claim 30, wherein the intrinsic properties are business values such as market capitalization, industry, years on the market, and market leadership.

33. The method of claim 30, wherein the intrinsic properties are threat values such as organizations, theatre of operation, economic threat, terror threat, military threat, past disruptive activities, and threat potential.

34. The method of claim 28, wherein the property is based on the party's relative location within the map.

35. The method of claim 34, wherein the relative location is based on sociometric values.

36. The method of claim 35, wherein the relative location is based on centrality measures, betweeness measures, brokerage measures, and distance measures.

37. A computer implemented method for mapping relations between parties, comprising:
receiving a search request concerning one or more search terms;
searching a repository of multiple objects for relevant objects based upon the search request, wherein the relevant objects include content objects, people objects, and source objects;
locating at least one relevant object in the repository;
identifying two or more parties that are related with the at least one relevant object;
determining a collaboration score for each pair of the two or more parties that increases with the at least one relevant object;
generating a representation of the relationship between the two or more parties, based on the relation score for each pair of the two or more parties;
generating a map based upon the relationship between the parties, the map consisting of nodes that represent the parties or their aggregates and edges connecting pairs of nodes that represent pairs of parties or their aggregates with relation scores above zero, above a predetermined score, below a predetermined score, or within a predetermined range of scores; and
displaying the map.

38. A system for mapping relations between parties comprising: at least one searcher device, creator device, and contributor device coupled to a network;
a repository containing multiple objects; and
an information retrieval system comprising:
a Central Processing Unit (CPU); and
a memory comprising:
instructions for receiving a search request concerning one or more search terms;
instructions for searching the repository of multiple objects for relevant objects based upon the search request;
instructions for locating at least one relevant object in the repository;
instructions for identifying two or more parties that are related with the at least one relevant object;
instructions for determining a relation score for each pair of the two or more parties that increases with the at least one relevant object; and
instructions for generating a representation of the relationship between the two or more parties or their aggregates, based on the relation score for each pair of the two or more parties.

39. The system in claim 38, wherein the multiple objects include content objects, people objects, and source objects.

40. The system of claim 38, further comprising:
prior to the instructions for locating, instructions for using a thesaurus to determine at least one additional search term; and
instructions for searching the repository of multiple objects for relevant objects based upon the such terms and the at least one additional search term.

41. The system of claim 38, wherein the instructions for searching are undertaken using a search technique selected from a group consisting of: semantic processing, syntactic processing, natural language processing, statistical processing, and any combination of the aforementioned techniques.

42. The method of claim 38, wherein the two or more parties are related to the at least one object if each of the two or more parties interacted with the relevant object or were mentioned within the relevant object.

43. The method of claim 38, wherein the parties include individuals, brands, places and any of their aggregates.

44. The method of claim 43, wherein the individual aggregates include individuals within a business unit, individuals within a corporation, or individuals within an industry.

45. The method of claim 44, wherein the individual aggregates further include individuals within a geographical boundary, individuals with a certain expertise, individuals with a certain capability, or individuals with a certain personal attribute.

46. The system of claim 38, wherein the instructions for determining further comprises:
instructions for identifying all permutations for pairs of the two or more parties;
instructions for calculating a preliminary relation score of each pair of parties for the at least one relevant object, where the preliminary relation score is dependent upon relations of each party with the at least one relevant object; and
instructions for aggregating preliminary relation scores of each pair of parties for all the relevant objects.

47. The system of claim 42, wherein the memory further comprises:
prior to the instructions for calculating, instructions for determining a relevancy score for each relevant object; and
wherein the instructions for calculating further comprises:
instructions for determining raw scores for the at least one relevant object based upon the each pair of parties' interactions with or mentions within the at least one relevant object; and
instructions for weighting the raw scores with the relevancy score to obtain the preliminary relation scores for each pair of parties;

48. The system of claim 42, wherein the instructions for aggregating further comprise:
instructions for summing all preliminary relation scores for each pair of parties; and
instructions for adjusting the sum of all preliminary relations scores for each pair of parties.

49. The system of claim 47, wherein only relevant objects having a relevance score above a predetermined relevancy score are used in the instructions for determining the relation scores.

50. The system of claim 47, wherein the raw score is 1 if both parties interacted with the relevant object, and the raw score is 0 if less than both of the parties are related to the relevant object.

51. The system of claim 49, wherein the relevancy score is set to 1 for all relevant objects.

52. The system of claim 42, wherein the instructions for aggregating further comprise:
prior to the instructions for calculating, instructions for determining an expertise score for each party; and
wherein the instructions for calculating is a function of the expertise scores for each pair of parties.

53. The system of claim 47, wherein the raw score is derived from relation pair values for pairs of interactions or mentions, the relation pair values indicating the degree of relation between pairs of parties based upon relations each party had with a common relevant object.

54. The system of claim 52, wherein the search request is provided by a searcher and the type of relation pair values to consider in calculating are predetermined by the searcher.

55. The system of claim 53, wherein the relation pair values are time dependent.

56. The system of claim 48, wherein the raw score is further based upon the time elapsed between each of the pair of parties' interactions with or mentions within the relevant object.

57. The method of claim 53, wherein the relation pair value is based upon the source of the at least one relevant object.

58. The method of claim 57, wherein the relation pair value is further based upon a searcher profile.

59. The system of claim 38, wherein the memory further comprises:
instructions for generating a map based upon the relationship between the parties, the map consisting of nodes that represent the parties and edges connecting pairs of nodes that represent pairs of parties with collaboration scores above zero; and
instructions for displaying the map.

60. The system of claim 57, wherein the instructions for displaying the map further include:
instructions for displaying only edges representing aggregate relation scores above a predetermined score, below a predetermined score, or within a predetermined range.

61. The system of claim 57, wherein the instructions for displaying the map are undertaken using color to indicate the aggregate relation score.

62. The system of claim 57, wherein the instructions for displaying the map are undertaken using a number associated with the edges to indicate the aggregate relation score.

63. The system of claim 57, wherein the instructions for displaying the map are undertaken using varying sizes of edges to indicate the aggregate relation score.

64. The system of claim 52, wherein the memory further comprises:
instructions for generating a map based upon the representation of the parties, the map consisting of nodes that represent the parties or their aggregates and edges connecting pairs of nodes that represent pairs of parties with relation scores above zero, above a predetermined score, below a predetermined score, or within a predetermined range of scores; and
instructions for displaying the map, wherein the expertise score of each party is indicated by the color, size, or shape of the nodes, or by a number adjacent to the node.

65. The method of claim 52, wherein the expertise score of each party is a score based on a certain property of the party.

66. The method of claim 65, wherein the property is of the expertise of the party.

67. The method of claim 65, wherein the property is based on the party's intrinsic properties.

68. The method of claim 67, wherein the intrinsic properties are personal to the party, such as age, years to retirement, job title, department, location of employment, salary, affiliations, and memberships.

69. The method of claim 67, wherein the intrinsic properties are business values such as market capitalization, industry, years on the market, and market leadership.

70. The method of claim 67, wherein the intrinsic properties are threat values such as organizations, theatre of operation, economic threat, terror threat, military threat, past disruptive activities, and threat potential.

71. The method of claim 65, wherein the property is based on the party's relative location within the map.

72. The method of claim 71, wherein the relative location is based on sociometric values.

73. The method of claim 72, wherein the relative location is based on centrality measures, betweeness measures, brokerage measures, and distance measures.

74. A system for mapping relations between parties comprising: at least one searcher device, creator device, and contributor device coupled to a network;
a repository containing multiple objects, wherein the multiple objects include content objects, people objects, and source objects; and
an information retrieval system comprising:
a Central Processing Unit (CPU); and
a memory comprising:
instructions for receiving a search request concerning one or more search terms;
instructions for searching the repository of multiple objects for relevant objects based upon the search request;
instructions for locating at least one relevant object in the repository;
instructions for identifying two or more parties that are related to the at least one relevant object;
instructions for determining a relation score for each pair of the two or more parties that increases with the at least one relevant object;
instructions for generating a representation of the relationship between the two or more parties or their aggregates, based on the relation score for each pair of the two or more parties or their aggregates;
instructions for generating a map based upon the relationship between the parties, the map consisting of nodes that represent the parties or their aggregates and edges connecting pairs of nodes that represent pairs of parties or their aggregates with relation scores above zero, above a predetermined score, below a predetermined score, or within a predetermined range of scores; and
instructions for displaying the map.
